(19) United States
(12) Patent Application Publication
(10) Pub. No.: US 2025/0306292 A1
(43) Pub. Date: Oct. 2, 2025

(54) OPTICAL MODULE AND OPTICAL CONNECTION STRUCTURE

(71) Applicant: FURUKAWA ELECTRIC CO., LTD., Tokyo (JP)

(72) Inventors: Noe Ishizuka, Tokyo (JP); Daiki Takeda, Tokyo (JP); Tsunetoshi Saito, Tokyo (JP)

(21) Appl. No.: 19/049,591

(22) Filed: Feb. 10, 2025

(30) Foreign Application Priority Data
Mar. 27, 2024 (JP) 2024-051486

(51) Int. Cl. G02B 6/38

(52) U.S. Cl. CPC G02B 6/3831; G02B 6/3882; G02B 6/3893; G02B 6/3897

(57) ABSTRACT

Holder-side fitting portions are provided on both sides of a ferrule holder. Also, housing-side fitting portions are provided on inner surfaces of front sidewall portions of a housing. The housing-side fitting portions are grooves formed on the inner surfaces of both sidewalls of the housing. The groove-shaped housing-side fitting portions provided on the inner surfaces of the ferrule holder and the protrusion-shaped holder-side fitting portions provided on outer surfaces of the ferrule holder fit together so that the ferrule holder is disposed at a predetermined position in the housing. Here, a clearance is formed between the holder-side fitting portion and the housing-side fitting portion. Thus, when the ferrule holder is attached to the housing, the ferrule holder is movable with respect to the housing.

### TECHNICAL FIELD

The present invention relates to an optical module and the like that can be connected to another optical connector.

### BACKGROUND OF THE INVENTION

For example, “OIF Co-Packaging Interoperability Demo” OFC 2022 March 8-10-SanDiego CA (https://www.oiforum.com/wp-content/uploads/OIF_Co-Packaging_Demo_OFC2022_Presentation.pdf) has proposed an external laser source (ELS) module including a built-in laser source therein, in which optical connection and electrical connection can be performed simultaneously. Such the ELS module includes an optical connecting portion that can be connected to another connector.

In such the optical module, it is necessary to fix a ferrule including a waveguide, which is to be connected to the internal laser source, to a housing of the optical module. In such the case, for example, a method in which the ferrule is attached to a holder for fixing the ferrule, the holder for fixing the ferrule is further fixed to a holder for fixing the housing, and the holder for fixing the housing is then attached to the housing may be used.

However, such the method is undesirable because of the large number of components, which increases cost as well as tolerances that accumulate when the components are assembled. Thus, a method in which the ferrule is fixed directly to a ferrule holder that can be attached to the housing has been awaited.

Here, at an optical connection portion where waveguides of optical connectors are optically connected to each other, an external force may be applied to the connector or the like, for example. Even at this time, to maintain optical connection, the ferrule inside the connector usually has freedom of movement (a so-called floating structure) to a certain extent with respect to a connector main body or the like. If there were no such floating structure, the ferrule would be completely positioned and fixed to the connector main body, and this may cause optical loss when the connector main body deforms and position of the ferrule is shifted.

However, since the ferrule is fixed to the ferrule holder without freedom, there is no floating structure between the ferrule and the ferrule holder. Thus, the ferrule has no freedom and loss at the optical connection portion may increase when an external force is applied to a connected portion with a connection target. In contrast, if the floating structure is to be obtained by providing a separate member between the ferrule holder and the housing as mentioned above, the number of components increases and this may cause deterioration of accuracy due to accumulation of tolerances.

### SUMMARY OF THE DISCLOSURE

The present invention was made in view of such problems. It is an object of the present invention to provide an optical module and the like in which a floating structure for a ferrule can be obtained with a simple structure.

To achieve the above object, a first aspect of the present invention is an optical module that can be connected to an optical connector. The optical module includes a ferrule holder for holding a ferrule and a housing to which the ferrule holder is to be attached. The ferrule holder includes a retaining portion with respect to the housing and a position restriction portion for restricting a position with respect to the housing. The position restriction portion is a holder-side fitting portion formed on an outer surface of the ferrule holder, and the holder-side fitting portion can fit into a housing-side fitting portion formed on an inner surface of the housing. A clearance is formed between the holder-side fitting portion and the housing-side fitting portion, and the ferrule holder is movable with respect to the housing.

The holder-side fitting portion may be in a protrusion shape that is formed on the outer surface of the ferrule holder, and the housing-side fitting portion may be in a groove shape that fits the protrusion-shaped holder-side fitting portion. The ferrule holder may be slidably inserted from a front side of the housing by fitting the holder-side fitting portion to the housing-side fitting portion.

An end of the holder-side fitting portion and an end of the housing-side fitting portion may have butting portions that come into contact with each other when the ferrule holder is inserted for a predetermined depth from the front side of the housing. At least one of the butting portions of the holder-side fitting portion and the housing-side fitting portion may be formed in a curved surface toward the other butting portion.

A protrusion may be formed on an outer side surface of the holder-side fitting portion or on an inner side surface of the housing-side fitting portion. The clearance between the holder-side fitting portion and the housing-side fitting portion may be smaller at a part of the protrusion than other parts.

According to the first aspect of the present invention, the clearance is formed between the holder-side fitting portion, which is formed on the outer surface of the ferrule holder, and the housing-side fitting portion, which is formed on the inner surface of the housing, and thus the ferrule holder is movable with respect to the housing. That is, a floating structure can be formed between the ferrule holder and the housing. This allows movement of the ferrule with respect to the housing.

Also, by forming the holder-side fitting portion and the housing-side fitting portion of a groove shape and a protrusion shape, respectively, that can be fitted to each other, the ferrule holder can be slidably inserted from the front side of the housing.

Also, by forming the butting portion between the end of the holder-side fitting portion and the end of the housing-side fitting portion of a curved surface, it is possible to make a contact area between the holder-side fitting portion and the housing-side fitting portion smaller, which allows the ferrule holder to move efficiently with respect to the housing.

Also, by forming the protrusion on the outer side surface of the holder-side fitting portion or on the inner side surface of the housing-side fitting portion and making the clearance smaller at the part of the protrusion than other parts, it is possible to improve positioning accuracy between the ferrule holder and the housing by the protrusion. Also, the contact area between the holder-side fitting portion and the housing-side fitting portion can be made smaller, which allows the ferrule holder to move efficiently with respect to the housing.

A second aspect of the present invention is an optical connection structure between the optical module according to the first aspect of the present invention and an optical connector. The optical connector includes an optical connection portion to be connected to the ferrule and a rough guide protrusion, which is to be inserted into the ferrule holder, on each side of the optical connection portion. The rough guide protrusion is inserted into a rough guide insertion portion of the ferrule holder and, at the same time, the ferrule and the optical connection portion are connected by guide mechanisms of a pin and a hole.

The rough guide protrusion may include a thick-diameter portion at a tip of a thin-diameter portion on a base side. In an initial state of inserting the rough guide protrusion into the rough guide insertion portion, a clearance therebetween may be relatively small. When the rough guide protrusion is further inserted into the rough guide insertion portion from the state in which the ferrule and the optical connection portion are positioned by the guide mechanisms, the clearance between the rough guide protrusion and the rough guide insertion portion may be relatively increased.

According to the second aspect of the present invention, by performing rough positioning using the rough guide protrusion of the optical connector and the rough guide insertion portion of the ferrule holder, positioning between the pin and the hole of the ferrule, which are the guide mechanisms for the optical connection portion, can be performed. Also, the guide mechanisms allow accurate positioning of the optical connection portions, thereby enabling efficient optical connection.

Also, by having the thin-diameter portion on the base side and the thick-diameter portion at the tip of the rough guide protrusion, in the initial state of inserting the rough guide protrusion into the rough guide insertion portion, the clearance therebetween can be made relatively smaller, thereby improving positioning effects. Meanwhile, when the rough guide protrusion is further inserted into the rough guide insertion portion from the state in which the optical module and the optical connection portion of the optical connector are positioned by the guide mechanisms, the clearance between the rough guide protrusion and the rough guide insertion portion relatively increases, which allows larger movement, thereby improving floating functions.

The present invention can provide an optical module and the like in which a floating structure for a ferrule can be obtained with a simple structure.

### BRIEF DESCRIPTION OF DRAWINGS

FIG. 1 is an exploded perspective view of an optical module 20.

FIG. 2 is an enlarged exploded perspective view of a ferrule holder 1 and a ferrule 3.

FIG. 3A is an assembled perspective view of the ferrule holder 1 and the ferrule 3.

FIG. 3B is an assembled plan view of the ferrule holder 1 and the ferrule 3.

FIG. 4 is an assembled perspective view of the optical module 20.

FIG. 5 is a front view of the optical module 20.

FIG. 6 is a cross-sectional view taken along A-A line in FIG. 5.

FIG. 7A is a perspective view of an optical connector 30.

FIG. 7B is a plan view of the optical connector 30.

FIG. 8A is a plan view of the optical connector 30 and the ferrule 3 before being connected.

FIG. 8B is a plan view of a state in which the optical connector 30 and the ferrule 3 are connected.

FIG. 9A is a view showing another structure in a state in which the optical connector 30 and the ferrule 3 are connected.

FIG. 9B is an enlarged view of a section B in FIG. 9A.

FIG. 9C is a view showing another embodiment of FIG. 9B.

FIG. 10A is a view showing another structure in a state in which the optical connector 30 and the ferrule 3 are connected.

FIG. 10B is an enlarged view of a section C in FIG. 10A.

FIG. 10C is a view showing another embodiment of FIG. 10B.

FIG. 11 is a view showing another structure in a state in which the optical connector 30 and the ferrule 3 are connected.

FIG. 12A is a view showing another structure in a state before the optical connector 30 and the ferrule 3 are connected.

FIG. 12B is an enlarged view of a section D in FIG. 12A.

FIG. 13A is a view showing a step of connecting the optical connector 30 and the ferrule 3.

FIG. 13B is a view showing a step of connecting the optical connector 30 and the ferrule 3.

### DETAILED DESCRIPTION

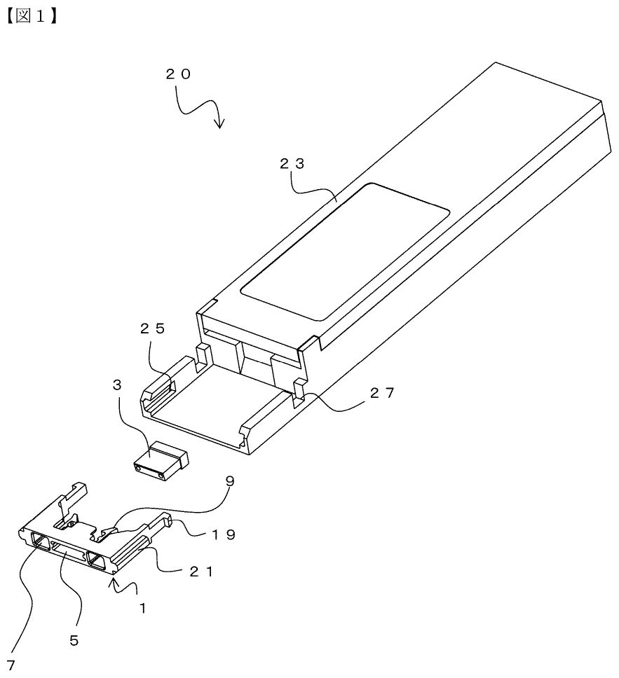

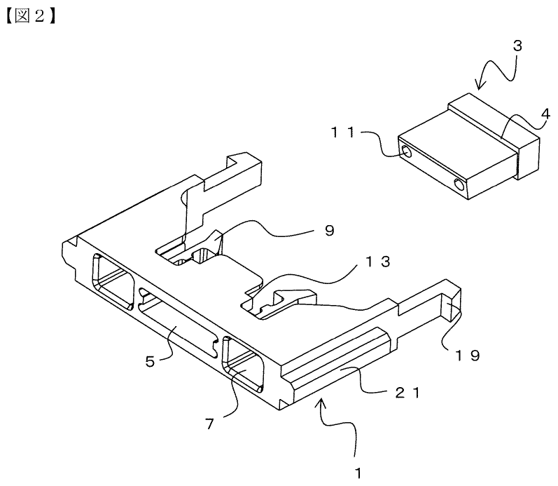

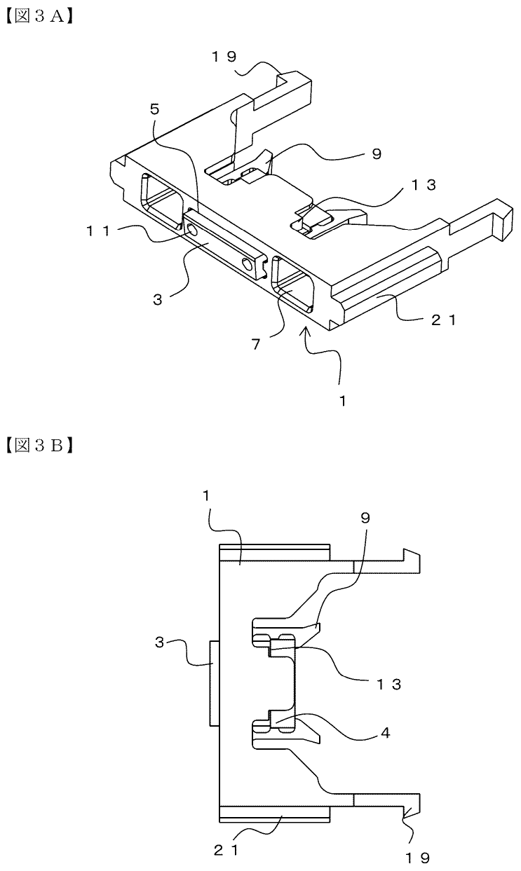

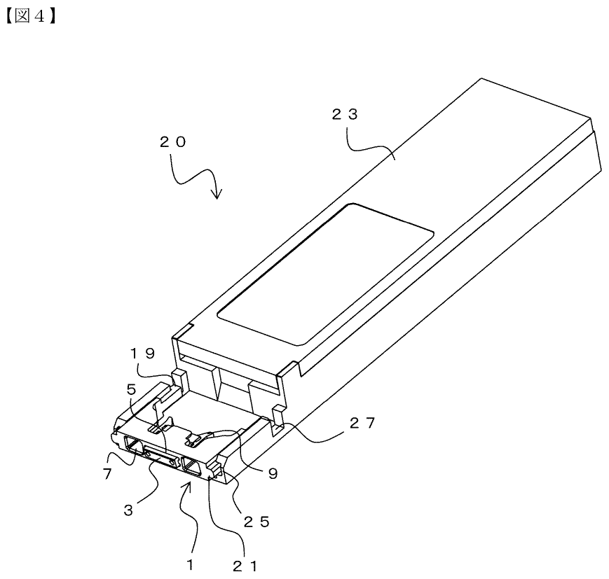

Hereinafter, an optical module according to an embodiment of the present invention will be described. FIG. 1 is an exploded perspective view of an optical module 20. Also, FIG. 2 is an enlarged exploded perspective view of a ferrule holder 1 and a ferrule 3, FIG. 3A is an assembled perspective view of the ferrule holder 1 and the ferrule 3, FIG. 3B is an assembled plan view of the ferrule holder 1 and the ferrule 3, and FIG. 4 is an assembled perspective view of the optical module 20. In FIG. 1, a lower left side (a connection direction with another optical connector, which will be described below) is to be a front of the optical module 20, and an upper right side is to be a rear of the optical module 20. Similarly, in FIG. 2, a lower left side is to be a front of the ferrule holder 1, and an upper right side is to be a rear of the ferrule holder 1.

The optical module 20 can be connected to another optical connector. The optical module 20 includes the ferrule holder 1, the ferrule 3, a housing 23, and so on. The housing 23 includes therein a built-in transmitter optical sub-assembly (TOSA) or the like having a built-in laser source, for example. That is, the optical module 20 is an ELS module, for example. Illustrations of substrates and electric connectors etc. accommodated inside the optical module 20 are omitted. The optical module may also be a module other than ELS modules.

The ferrule 3 includes therein a waveguide such as an optical fiber, and the waveguide is optically connected to the laser source inside the housing 23. Also, an end surface of the waveguide (of which illustration is omitted) is exposed at a front surface of the ferrule 3. The number of the waveguide exposed at the front surface of the ferrule 3 may be one or more.

As shown in FIG. 2, a guide hole 11 is provided on each side of the waveguide on the front surface of the ferrule 3. The guide hole 11 is a part into which a guide pin of a connection target, which will be described below, is to be inserted. A convex portion 4 protruding at least in upper and lower directions is provided at the rear of the ferrule 3.

The ferrule holder 1 includes a ferrule-insertion hole 5, which penetrates and opens in an optical connection direction (from the front to the rear). The ferrule 3 can be inserted into the ferrule-insertion hole 5.

Also, a rough guide hole 7 is provided on each side of the ferrule-insertion hole 5 of the ferrule holder 1. The rough guide hole 7 penetrates the ferrule holder 1 in the optical connection direction of the ferrule holder 1 (from the front to the rear). The rough guide hole 7 is a part into which a rough guide protrusion of the connection target, which will be described below, is to be inserted.

Also, a pair of ferrule holding latches 9 are disposed at the rear of the ferrule holder 1 on both side portions of the ferrule-insertion hole 5. The ferrule holding latches 9 are disposed on both sides of the ferrule-insertion hole 5 such that hooks thereof face each other.

Also, ferrule butting portions 13 are provided between the ferrule holding latches 9. The ferrule butting portions 13 are provided vertically within the ferrule-insertion hole 5 and protrude in mutually opposing directions.

As shown in FIG. 3A and FIG. 3B, the ferrule 3 can be inserted into the ferrule-insertion hole 5 from the rear of the ferrule holder 1. At this time, the ferrule holding latches 9 are pushed open and deformed so that the ferrule 3 can be inserted into the ferrule-insertion hole 5. Also, when the ferrule 3 is pushed until the convex portion 4 of the ferrule 3 is butted against the ferrule butting portions 13 of the ferrule holder 1, deformation of the ferrule holding latches 9 is restored and the hooks are engaged at the rear of the ferrule 3. In this way, the ferrule holder 1 holds the ferrule 3.

As shown in FIG. 2, holder-holding latches 19 are provided at proximities of both side portions of the ferrule holder 1. The holder-holding latches 19 include hooks, respectively, that are formed facing outer sides. Also, as shown in FIG. 1, concave-shaped holder-holding portions 27 are provided on front sidewall portions of the housing 23. The holder-holding latches 19 can be engaged with the holder-holding portions 27.

Also, as shown in FIG. 2, a holder-side fitting portion 21 is provided on each side surface of the ferrule holder 1. The holder-side fitting portions 21 is in a protrusion shape formed on each side surface of the ferrule holder 1. The holder-side fitting portion 21 protrudes outward in a width direction and formed continuously from the front to the rear with a predetermined length.

Also, as shown in FIG. 1, a housing-side fitting portion 25 is provided on an inner surface of the front sidewall portion of the housing 23. The housing-side fitting portions 25 is in a groove shape formed on each inner surface of the sidewall of the housing 23. The housing-side fitting portion 25 opens to a front of the housing and is formed from the front to the rear continuously to have a predetermined length.

The ferrule holder 1 is slid and inserted from the front of the housing 23 such that the holder-side fitting portion 21 of the ferrule holder 1 fits into the housing-side fitting portion 25 of the housing 23. In this way, as shown in FIG. 4, the holder-holding latches 19 are engaged with the holder-holding portions 27 so that the ferrule holder 1 can be attached to the housing 23. That is, the holder-holding latches 19 function as a fall-off stopper with respect to the housing 23. The mechanism for preventing the ferrule holder from falling off is not particularly limited.

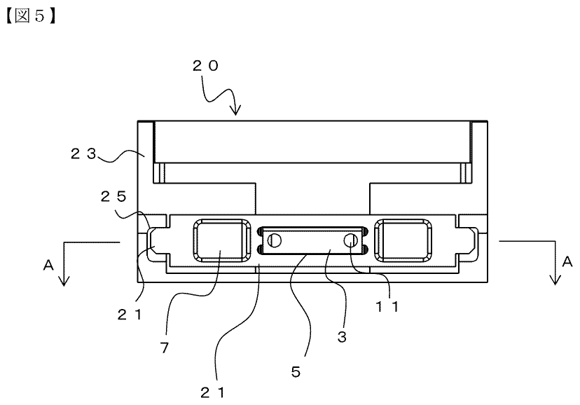

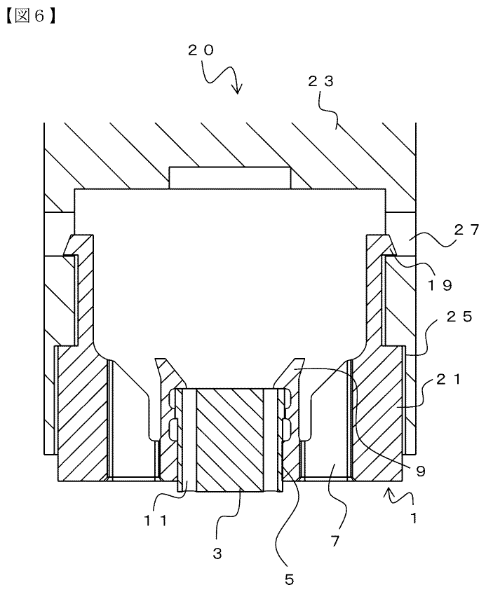

FIG. 5 is a front view of the optical module 20 and FIG. 6 is a cross-sectional view taken along A-A line in FIG. 5. As mentioned above, by fitting the groove-shaped housing-side fitting portion 25 provided on the inner surface of the housing 23 with the protrusion-shaped holder-side fitting portion 21 provided on the outer surface of the ferrule holder, the ferrule holder 1 is disposed at a predetermined position of the housing 23. That is, the holder-side fitting portion 21 fits into the housing-side fitting portion 25 so as to function as a position restricting portion that restricts a position with respect to the housing 23. A cross-sectional shape of the holder-side fitting portion 21 and the housing-side fitting portion 25 taken perpendicularly to the connection direction is not limited to the illustrated example, and may be formed in a curved surface such as a semi-circle, or may be formed of a polygon such as a rectangle.

Here, a clearance is formed between the holder-side fitting portion 21 and the housing-side fitting portion 25. Thus, the ferrule holder 1 is movable with respect to the housing 23 when the ferrule holder 1 is attached to the housing 23. For example, the ferrule holder 1 is allowed to move, with respect to the housing 23, in a left-right direction and in a height direction (a direction vertical to the drawing), which is orthogonal to the left-right direction, as well as in a rotational direction with the connection direction as a rotation axis. Since the ferrule holder 1 has positional freedom with respect to the housing 23 in this way, even if an external force or the like is applied at the time of connection with the connection target, which will be described below, the ferrule 3 can still move with respect to the housing 23 and the optical connection can be maintained. That is, floating functions can be exhibited at the position restricting portion of the holder-side fitting portions 21 and the housing-side fitting portions 25.

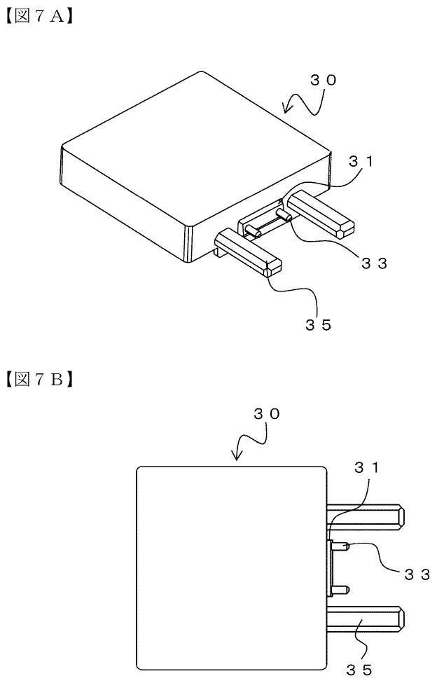

Next, a method for connecting the optical module 20 to another optical connector will be described. FIG. 7A is a perspective view showing an optical connector 30, which is an optical connection target, and FIG. 7B is a plan view of the optical connector 30. The optical connector 30 includes a ferrule 31 having a built-in waveguide. That is, the waveguide (of which illustration is omitted) of the ferrule 31 of the optical connector 30 is to be an optical connection portion that is to be optically connected to the waveguide of the ferrule 3 fixed to the ferrule holder 1.

In the optical connector 30, the ferrule 31 includes a known floating structure with respect to the connector main body. For example, an elastic member that presses the ferrule 31 toward the connection direction is accommodated at the rear of the ferrule 31, and the ferrule 31 can move slightly with respect to the connector main body by deformation of the elastic member.

A guide pin 33 protruding toward the connection direction is provided on each side of the optical connection portion of the ferrule 31. The guide pin 33 is inserted into the guide hole 11 of the ferrule 3 to be connected, and serves as a positioning part during optical connection. That is, a pair of the guide pins 33 are disposed at positions corresponding to the guide holes 11 on both sides of the optical connection portion.

A rough guide protrusion 35 is disposed on each side of the ferrule 31 (the optical connection portion) of the optical connector 30. The rough guide protrusion 35 protrudes in a connection direction with the ferrule holder 1 (the right direction in FIG. 7B). A cross-sectional shape of the rough guide protrusion 35 may be in a circle or in a polygon such as a rectangle. The rough guide protrusion 35 is disposed at a position that corresponds to the rough guide hole 7 of the ferrule holder 1.

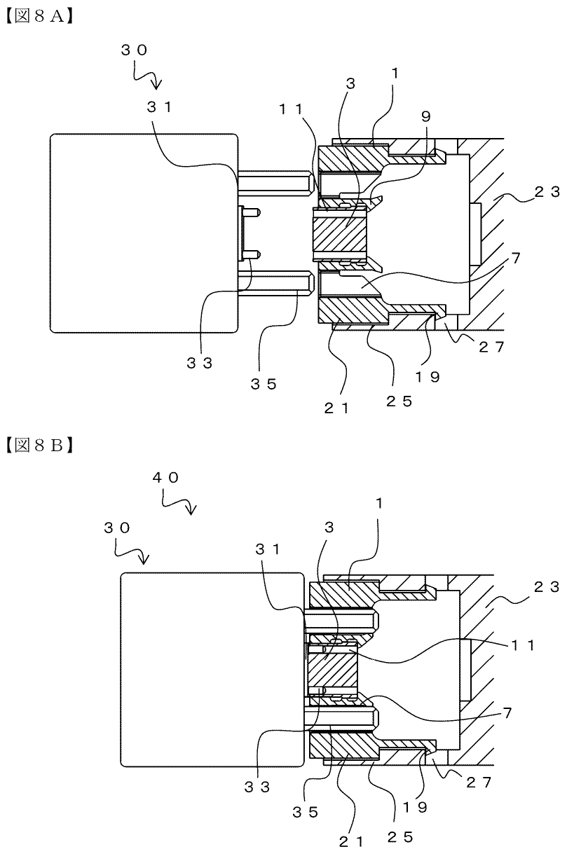

FIG. 8A is a view showing a state in which the optical connector 30 faces the ferrule holder 1 attached to the housing 23. Note that the housing 23 and the ferule holder 1 and the like are shown in cross-sectional views. To connect the optical connector 30 and the ferrule holder 1, the rough guide protrusion 35 of the optical connector 30 is inserted into the rough guide hole 7 first. Since a cross section of the rough guide protrusion 35 is smaller than a cross section of the rough guide hole 7 and there is an enough clearance, the rough guide protrusion 35 can be easily inserted into the rough guide hole 7. In the present embodiment, the rough guide hole 7 will be described as having a shape into which the rough guide protrusion 35 can be inserted. However, the shape of a rough guide insertion portion into which the rough guide protrusion 35 can be inserted does not necessarily have to be a hole, and there is no particular restriction as long as the rough guide insertion portion has a shape that allows the rough guide protrusion to be inserted.

When a predetermined length of the rough guide protrusion 35 is inserted into the rough guide hole 7, the guide pin 33 is then inserted into the guide hole 11. FIG. 8B is a view showing a connection structure between the ferrule holder 1 and the optical connector 30, in which the guide pin 33 is inserted into the guide hole 11. By inserting the rough guide protrusion 35 into the rough guide hole 7 in this way, rough positioning of the guide pin 33 and the guide hole 11 is possible, and the guide pin 33 can be inserted into the guide hole 11.

With the guide pin 33 and the guide hole 11, which are guide mechanisms for optical connection, end faces of the optical waveguide of the ferrule 3 and the optical waveguide of the ferrule 31 are aligned with each other to perform optical connection, and an optical connection structure 40 can be obtained.

Here, in the optical connection structure 40, if an external force is applied at proximity of a connected portion between the optical module 20 and the optical connector 30, the connected portion between the housing 23 and the optical connector 30 may slightly deform. At this time, as mentioned above, since the ferrule 31 of the optical connector 30 is slightly movable with respect to the connector main body, change in position of the ferrule 31 (the relative position with respect to the ferrule 3) can be suppressed even if the connector main body deforms a little.

Meanwhile, although the ferrule holder 1 is positioned to the housing 23 by fitting the holder-side fitting portion 21 to the housing-side fitting portion 25, the clearance is formed between the holder-side fitting portion 21 and the housing-side fitting portion 25 as mentioned above, and thus the ferrule holder 1 is movable with respect to the housing 23. Thus, change in position of the ferrule 3 (the relative position with respect to the ferrule 31) can be suppressed even if the housing 23 deforms a little. That is, the respective floating structures of the optical module 20 and the optical connector 30 can minimize influence on the optical connection portion.

As above, according to the present embodiment, the clearance formed at a fitted portion between the ferrule holder 1 holding the ferrule 3 and the housing 23 allows the ferrule holder 1, to which the ferrule 3 is fixed, to move with respect to the housing 23 and to function as a floating structure. Also, the protrusion-shaped holder-side fitting portion 21 is slid and inserted into the groove-shaped housing-side fitting portion 25, and thus an assembling operation is easy. Also, there is no need to use separate members and thus the structure is simple, which can improve assembly accuracy.

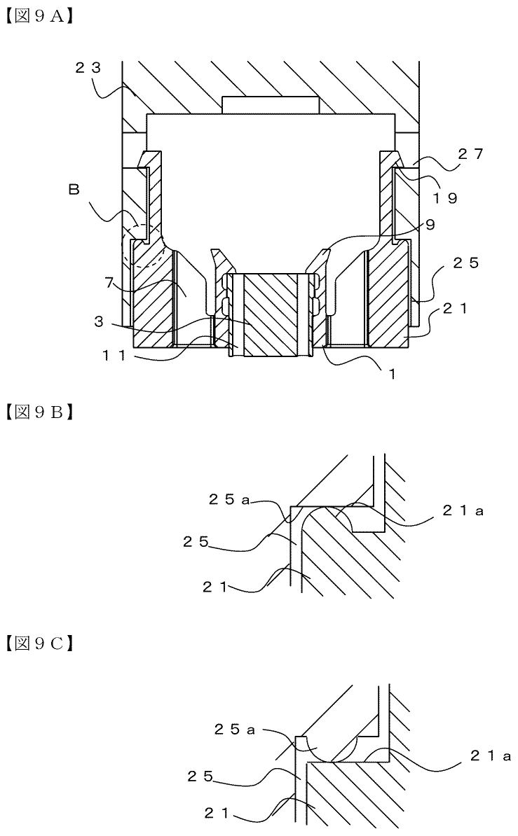

Next, a second embodiment will be described. FIG. 9A is a view showing a shape of the ferrule holder 1 according to the second embodiment, and FIG. 9B is an enlarged view of a section B in FIG. 9A. In the descriptions hereafter, structures exhibiting the similar functions as in the first embodiment will have the same notations as in FIG. 1 to FIG. 8B and redundant descriptions will be omitted.

The second embodiment is substantially similar to the first embodiment except for a shape of a butting portion 21a at a tip end of the holder-side fitting portion 21 of the ferrule holder 1. The holder-side fitting portion 21 can be inserted into the housing-side fitting portion 25 until the tip end of the protrusion-shaped holder-side fitting portion 21 is butted against the deepest part of the groove-shaped housing-side fitting portion 25. That is, an end of the holder-side fitting portion 21 and an end of the housing-side fitting portion 25 include butting portions 21a and 25a, respectively, that come into contact with each other when the ferrule holder 1 is inserted from the front of the housing 23 for a predetermined depth.

When the ferrule holder 1 is inserted into the housing 23 until the butting portion 21a of the holder-side fitting portion 21 is in contact with the butting portion 25a of the housing-side fitting portion 25, the above-mentioned hooks of the holder-holding latches 19 are engaged with the holder-holding portions 27. At this time, there may be a little gap formed between the butting portion 21a of the ferrule holder 1 and the butting portion 25a of the housing 23.

Here, in the present embodiment, the butting portion 21a of the holder-side fitting portion 21 is formed in a curved surface toward the butting portion 25a of the housing-side fitting portion 25. By making the butting portion 21a in a curved surface in this way, the butting portions of the ferrule holder 1 and the housing 23 are in point contact with each other, which can suppress surface contact between the both.

For example, if the butting portion 21a of the holder-side fitting portion 21 and the butting portion 25a of the housing-side fitting portion 25 both have plane surfaces, the both are in surface contact with each other when being butted to each other. In a state of such the surface contact, a contact state thereof is stabilized, thereby obstructing relative movement between the both. That is, effects of the floating structures may not be fully exhibited.

In contrast, if the butting portion 21a of the holder-side fitting portion 21 and the butting portion 25a of the housing-side fitting portion 25 are in point contact, it is possible to intentionally make the contact state between the both at the butting portions unstable, and the ferrule holder 1 can move with respect with the housing 23 even with a small force. That is, the effects of the floating structures can be fully exhibited.

As shown in FIG. 9C, the butting portion 25a of the housing-side fitting portion 25 may be formed in a curved surface toward the butting portion 21a of the holder-side fitting portion 21. The similar effects can be obtained when the butting portion 25a is formed in a curved surface as above. That is, at least one of the butting portions 21a and 25a of the holder-side fitting portion 21 and the housing-side fitting portion 25 may be formed in a curved surface toward the other butting portion 21a or 25a.

According to the second embodiment, the similar effects as in the first embodiment can be obtained. Also, by forming the butting portions 21a or 25a in a curved surface when the ferrule holder 1 is slid and inserted into the housing 23, relative movement of the ferrule holder 1 with respect to the housing 23 can be facilitated and the effects of the floating structure of the ferrule holder 1 with respect to the housing 23 can be fully exhibited.

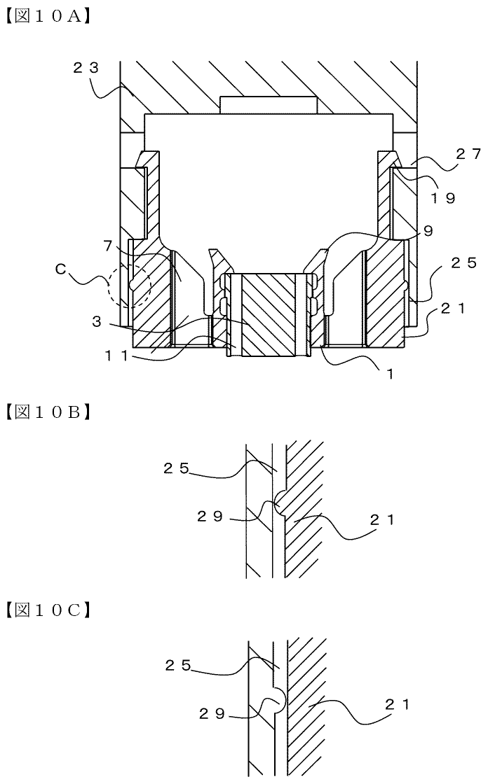

Next, a third embodiment will be described. FIG. 10A is a view showing a shape of the ferrule holder 1 according to the third embodiment, and FIG. 10B is an enlarged view of a section C in FIG. 10A. The third embodiment is substantially similar to the first embodiment except for a shape of the side surface of the holder-side fitting portion 21 of the ferrule holder 1.

A protrusion 29 protruding outward in a width direction is formed on an outer side surface of the holder-side fitting portion 21. The protrusion 29 is formed in a curved surface in a semi-sphere, for example. The protrusion 29 protrudes toward an inner surface of the housing-side fitting portion 25, and thus the clearance between the holder-side fitting portion 21 and the housing-side fitting portion 25 is smaller at a part with the protrusion 29 than other parts without the protrusion 29.

In this way, since the clearance between the holder-side fitting portion 21 and the housing-side fitting portion 25 is smaller at the protrusion 29, accuracy for positioning the ferrule holder 1 and the housing 23 can be improved. On the other hand, at the parts without the protrusion 29, the clearance can be secured between the holder-side fitting portion 21 and the housing-side fitting portion 25, thereby achieving the effects of the floating structure.

Instead of forming the protrusion 29 on the holder-side fitting portion 21, the protrusion 29 may be formed on the inner side surface of the housing-side fitting portion 25 as shown in FIG. 10C. Also in such the case, the protrusion 29 protrudes toward the outer surface of the holder-side fitting portion 21 and thus the clearance between the holder-side fitting portion 21 and the housing-side fitting portion 25 is smaller at the part of the protrusion 29 than at other parts without the protrusion 29. By forming the protrusion 29 on at least one of the outer side surface of the holder-side fitting portion 21 and the inner side surface of the housing-side fitting portion 25 in this way, it is possible to make the clearance between the holder-side fitting portion 21 and the housing-side fitting portion 25 smaller at the part of the protrusion 29 than other parts without the protrusion 29.

Although the protrusion 29 is disposed at a substantial center of the holder-side fitting portion 21 or the housing-side fitting portion 25 with respect to an insertion direction of the ferrule holder 1 into the housing 23 (upper and lower directions in FIG. 10A), it is not limited thereto. For example, by disposing the protrusion 29 being shifted toward the front side of the holder-side fitting portion 21 or the housing-side fitting portion 25 (downward in FIG. 10A), position accuracy on an end face side of the ferrule 3 can be improved. On the other hand, by disposing the protrusion 29 being shifted toward the rear side of the holder-side fitting portion 21 or the housing-side fitting portion 25 (upward in FIG. 10A), positional freedom of the end face side of the ferrule 3 can be improved.

According to the third embodiment, the same effects as in the first embodiment can be obtained. Also, forming the protrusion on the outer side surface of the holder-side fitting portion 21 or on the inner side surface of the housing-side fitting portion 25 can improve the position accuracy while still maintaining the floating structure.

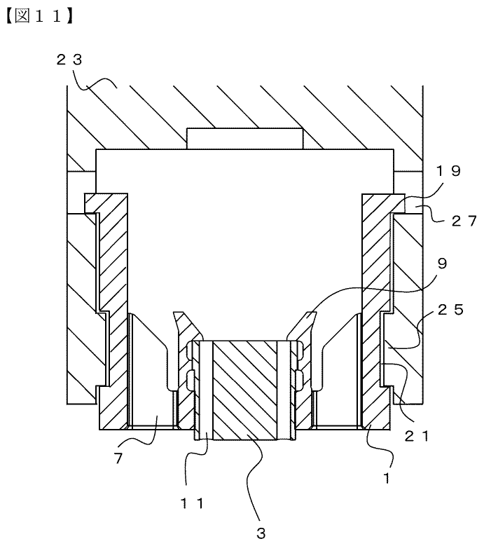

Next, a fourth embodiment will be described. FIG. 11 is a view showing a fitting state between the ferrule holder 1 and the housing 23 according to the fourth embodiment. The fourth embodiment is substantially similar to the first embodiment except that the holder-side fitting portion 21 of the ferrule holder 1 is in a groove shape and the inner side face of the housing-side fitting portion 25 of the housing 23 is formed in a protrusion shape.

Note that, in such the case, it is impossible to slide and insert the ferrule holder 1 from the front of the housing 23. Thus, the ferrule holder 1 is fitted into the housing 23 from above (a direction perpendicular to the paper surface of FIG. 11) so that the ferrule holder 1 can be attached to the housing 23.

According to the fourth embodiment, the same effects as in the first embodiment can be obtained. As above, the holder-side fitting portion 21 may not necessarily be in a protrusion shape and the housing-side fitting portion 25 may not necessarily be in a groove shape.

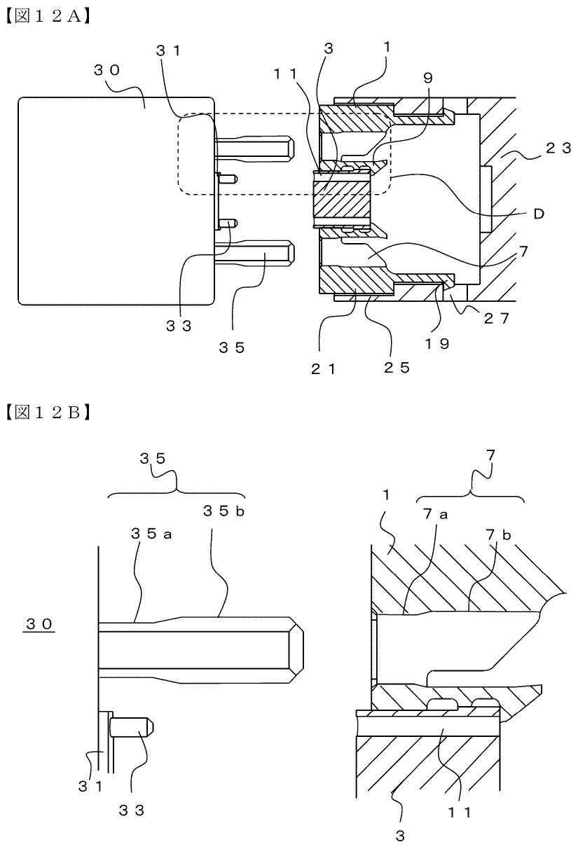

Next, a fifth embodiment will be described. FIG. 12A is a view showing a state before fitting the ferrule holder 1 to the housing 23 according to the fifth embodiment, and FIG. 12B is an enlarged view of a section D in FIG. 12A. The fifth embodiment is substantially similar to the first embodiment except for shapes of the rough guide protrusion 35 and the rough guide hole 7.

In the present embodiment, the rough guide protrusion 35 includes a thin-diameter portion 35a having a relatively small diameter (including in width and height, the same applies hereafter) on a base side (on the left side in FIG. 12B), and a thick-diameter portion 35b having a relatively large diameter on a tip side of the thin-diameter portion 35a (on the right side of FIG. 12B). Also, the guide hole 7 has a small-diameter portion 7a having a relatively small diameter on a front end side thereof (the left side in FIG. 12B) and a large-diameter portion 7b having a relatively large diameter on a back side thereof (on the right side in FIG. 12B). A depth of the rough guide hole 7 may be reduced so as to leave only the small-diameter portion 7a.

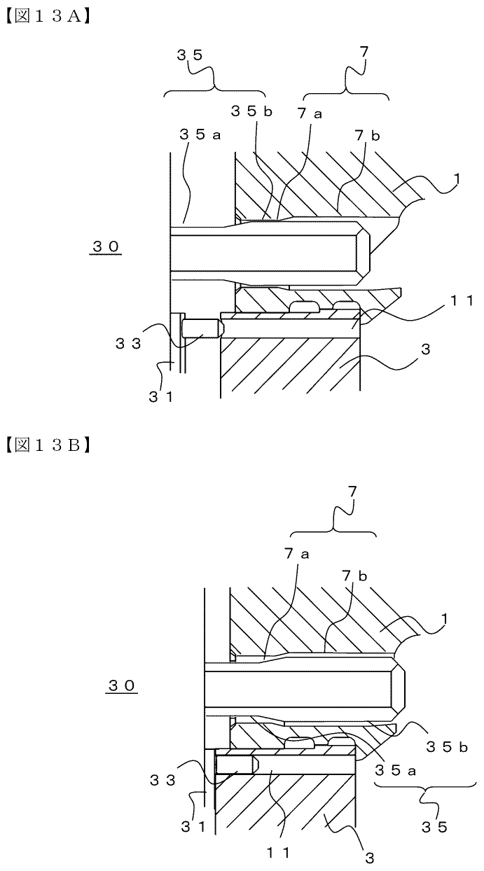

FIG. 13A is a view showing an initial state of inserting the rough guide protrusion 35 into the rough guide hole 7. As mentioned above, since the tip side of the rough guide protrusion 35 is the thick-diameter portion 35b and the front end part of the rough guide hole 7 is the small-diameter portion 7a, the thick-diameter portion 35b of the rough guide protrusion 35 is inserted into the small-diameter portion 7a of the rough guide hole 7 first. That is, the small-diameter portion 7a has a size that allows the thick-diameter portion 35b to be inserted therein.

Since a clearance between the thick-diameter portion 35b of the rough guide protrusion 35 and the small-diameter portion 7a of the rough guide hole 7 is small, the ferrule holder 1 and the optical connector 30 are positioned with relatively high accuracy. Also, when the rough guide protrusion 35 is inserted into the rough guide hole 7, a tip of the guide pin 33 of the ferrule 31 reaches the guide hole 11 of the ferrule 3 in a state in which the thick-diameter portion 35b is positioned at the small-diameter portion 7a. Thus, the guide pin 33 and the guide hole 11 can be positioned with high accuracy.

The rough guide protrusion 35 is further inserted into the rough guide hole 7, and when the guide pin 33 of the ferrule 31 is completely inserted into the guide hole 11 of the ferrule 3 as shown in FIG. 13B, the thick-diameter portion 35b of the rough guide protrusion 35 passes through the small-diameter portion 7a of the rough guide hole 7 to be inserted to a position of the large-diameter portion 7b. In such the state, the thin-diameter portion 35a of the rough guide protrusion 35 is positioned at the small-diameter portion 7a of the rough guide hole 7, and thus, compared to the state in FIG. 13A, a clearance between the rough guide protrusion 35 and the rough guide hole 7 becomes larger.

This allows relative movement between the ferrule holder 1 and the main body of the optical connector 30. Also, as mentioned above, the ferrule 31 has the floating structure with respect to the main body of the optical connector 30. Thus, even in a state in which the ferrule 31 and the ferrule 3 are completely fixed with each other, the ferrule 31 and the ferrule 3 are movable with respect to the optical connector main body.

Also, as mentioned above, the clearance between the rough guide protrusion 35 and the rough guide hole 7 is sufficiently large, and thus the main body of the optical connector 30 and the ferrule holder 1 can move relatively. Furthermore, since the ferrule holder 1 is also movable with respect to the housing 23, an allowable range of movement of the ferrule 31 and the ferrule 3 with respect to the housing 23 can be expanded. As above, the floating functions of both the optical connector 30 and the optical module 20 can be efficiently exhibited.

According to the fifth embodiment, the same effects as in the first embodiment can be obtained. Also, in the initial state of inserting the rough guide protrusion 35 into the rough guide hole 7, the clearance therebetween is made small and thus the guide pin 33 and the guide hole 11, which are the guide mechanisms, can be positioned with high accuracy. Also, when the rough guide protrusion 35 is further inserted into the rough guide hole 7 from the state in which the optical connection portions of the ferrule 3 and the ferrule 31 are positioned by the guide mechanisms, the clearance between the rough guide protrusion 35 and the rough guide hole 7 can be relatively increased. Thus, positional restriction between the main body of the optical connector 30 and the ferrule holder 1 is reduced and the floating functions can be efficiently exhibited.

The rough guide insertion portion into which the rough guide protrusion 35 can be inserted may not be the rough guide hole 7. For example, instead of the rough guide hole 7, a notch shape without a beam portion on either the top or bottom may also be used.

Also, the descriptions on the present embodiments have been given using an ELS (External Laser Source) module as an example. However, the scope of application of the present invention is not limited to ELS modules. For example, the present invention can be applied to optical connection portions of pluggable transceivers that have been widely used in the field of optical communication. In such the case, by using the compact connector mechanism of the present invention, it is possible to install the connector in a smaller space than when a conventional MPO connector is used, and it is also possible to install two or more connectors side by side.

Although the embodiments of the present invention have been described referring to the attached drawings, the technical scope of the present invention is not limited to the embodiments described above. It is obvious that persons skilled in the art can think out various examples of changes or modifications within the scope of the technical idea disclosed in the claims, and it will be understood that they naturally belong to the technical scope of the present invention.

For example, it is needless to say that the structures in the above embodiments can be combined with one another.

1. An optical module that can be connected to an optical connector, the optical module comprising:
a ferrule holder for holding a ferrule; and
a housing to which the ferrule holder is to be attached, wherein:
the ferrule holder includes a retaining portion with respect to the housing and a position restriction portion for restricting positions with respect to the housing;
the position restriction portion is a holder-side fitting portion formed on an outer surface of the ferrule holder, and the holder-side fitting portion can fit into a housing-side fitting portion formed on an inner surface of the housing; and
a clearance is formed between the holder-side fitting portion and the housing-side fitting portion and the ferrule holder is movable with respect to the housing.

2. The optical module according to claim 1, wherein:
the holder-side fitting portion is in a protrusion shape that is formed on the outer surface of the ferrule holder, and the housing-side fitting portion is in a groove shape that fits the protrusion-shaped holder-side fitting portion; and
the ferrule holder is slidably inserted from a front side of the housing by fitting the holder-side fitting portion to the housing-side fitting portion.

3. The optical module according to claim 2, wherein:
an end of the holder-side fitting portion and an end of the housing-side fitting portion have butting portions that come into contact with each other when the ferrule holder is inserted for a predetermined depth from the front side of the housing; and
at least one of the butting portions of the holder-side fitting portion and the housing-side fitting portion is formed in a curved surface toward the other butting portion.

4. The optical module according to claim 2, wherein:
a protrusion is formed on an outer side surface of the holder-side fitting portion or on an inner side surface of the housing-side fitting portion; and
the clearance between the holder-side fitting portion and the housing-side fitting portion is smaller at a part of the protrusion than other parts.

5. An optical connection structure between the optical module according to claim 1 and an optical connector, the optical connector comprising:
an optical connection portion to be connected to the ferrule; and
a rough guide protrusion, which is to be inserted into the ferrule holder, on each side of the optical connection portion, wherein the rough guide protrusion is inserted into a rough guide insertion portion of the ferrule holder and, at the same time, the ferrule and the optical connection portion are connected by guide mechanisms of a pin and a hole.

6. The optical connection structure according to claim 5, wherein:
the rough guide protrusion includes a thick-diameter portion at a tip of a thin-diameter portion on a base side;
in an initial state of inserting the rough guide protrusion into the rough guide insertion portion, a clearance therebetween is relatively small; and
when the rough guide protrusion is further inserted into the rough guide insertion portion from the state in which the ferrule and the optical connection portion are positioned by the guide mechanisms, the clearance between the rough guide protrusion and the rough guide insertion portion is relatively increased.
